(19) United States
(12) Patent Application Publication
(10) Pub. No.: US 2013/0225112 A1
(43) Pub. Date: Aug. 29, 2013

(54) SYSTEM AND/OR METHOD FOR PROVIDING AN EMERGENCY CONTACT TELEPHONE NUMBER

(71) Applicants: Alan E. Frey, Naperville, IL (US); John L. Ostrander, Naperville, IL (US)

(72) Inventors: Alan E. Frey, Naperville, IL (US); John L. Ostrander, Naperville, IL (US)

(73) Assignee: Alcatel-Lucent USA Inc., Murray Hill, NJ (US)

(21) Appl. No.: 13/409,082

(22) Filed: Feb. 29, 2012

(51) Int. Cl. H04W 4/22; H04M 11/04

(52) U.S. Cl. 455/404.1; 379/37

(57) ABSTRACT

A method is provided for utilizing an emergency contact number in a telecommunications network (32). The method includes: identifying a first call directed to an emergency contact number; notifying a first user equipment (20) of the identified first call; recognizing a second call from the first user equipment (20) to the emergency contact number as a request to connect the second call with the first call; and, supporting a connection of the first and second calls with one another.

### BACKGROUND

The present inventive subject matter relates generally to the art of telecommunications. Particular but not exclusive relevance is found in connection with mobile telephones, and accordingly the present specification makes specific reference thereto. It is to be appreciated however that aspects of the present inventive subject matter are also equally amenable to other like applications.

Often people may leave an emergency contact telephone number with an individual or organization, so that the individual or organization may call them at that telephone number in case of an emergency. For example, a parent may provide a school with their telephone number so that the school can call the parent in case there is an emergency concerning their child. However, that parent may not always be available to accept the call at the provided telephone number. Of course, this can be undesirable if an emergency occurs at such times.

One solution is to provide the calling party with one or more alternate emergency contact telephone numbers, e.g., of other family members or people who may be available to handle emergencies or of other telephones where the primary emergency contact may be reached. As can be appreciated, this solution has certain limitations and/or drawbacks. For example, the calling party may have to call multiple telephone numbers before someone is reached. Additionally, an individual called may not be made aware if another called individual has already spoke with the calling party and/or addressed the emergency.

Accordingly, a new and/or improved method, apparatus, mobile application and/or system is disclosed which addresses the above-referenced problem(s) and/or others.

### SUMMARY

This summary is provided to introduce concepts related to the present inventive subject matter. The summary is not intended to identify essential features of the claimed subject matter nor is it intended for use in determining or limiting the scope of the claimed subject matter. The embodiments described below are not intended to be exhaustive or to limit the invention to the precise forms disclosed in the following detailed description. Rather, the embodiments are chosen and described so that others skilled in the art may appreciate and understand the principles and practices of the present inventive subject matter.

In accordance with one embodiment, a method is provided for utilizing an emergency contact number in a telecommunications network. The method includes: identifying a first call directed to an emergency contact number; notifying a first user equipment of the identified first call; recognizing a second call from the first user equipment to the emergency contact number as a request to connect the second call with the first call; and, supporting a connection of the first and second calls with one another.

In accordance with another embodiment, a method is provided for utilizing an emergency contact number in a telecommunications network. The method includes: sending a first notification request from a first mobile telephone to a node of the telecommunications network, the first notification request requesting that the first mobile telephone be notified if a call is directed to a designated emergency contact number; receiving at the first mobile telephone a first notification when a first call is directed to the designated emergency contact number; in response to receiving the first notification, providing a first user of the first mobile telephone an option to connect with the first call; and, if the first user selects the option, placing a second call from the first mobile telephone to the designated emergency contact number, the second call being connected to the first call.

Numerous advantages and benefits of the inventive subject matter disclosed herein will become apparent to those of ordinary skill in the art upon reading and understanding the present specification. It is to be understood, however, that the detailed description of the various embodiments and specific examples, while indicating preferred and other embodiments, are given by way of illustration and not limitation. Many changes and modifications within the scope of the present invention may be made without departing from the spirit thereof, and the invention includes all such modifications.

### BRIEF DESCRIPTION OF THE DRAWING(S)

The following detailed description makes reference to the figures in the accompanying drawings. However, the inventive subject matter disclosed herein may take form in various components and arrangements of components, and in various steps and arrangements of steps. The drawings are only for purposes of illustrating exemplary and/or preferred embodiments and are not to be construed as limiting. Further, it is to be appreciated that the drawings may not be to scale.

FIG. 1 is a diagrammatic illustration showing a telephony application server and mobile user equipment suitable for practicing aspect of the present inventive subject matter.

FIG. 2 is a post and rail diagram illustrating a partial call flow suitable for practicing aspects of the present inventive subject matter.

FIG. 3 is a post and rail diagram illustrating a continuation of the call flow from FIG. 2, where the top of FIG. 3 continues from the bottom of FIG. 2.

FIG. 4 is a post and rail diagram illustrating a continuation of the call flow from FIG. 3, where the top of FIG. 4 continues from the bottom of FIG. 3.

FIG. 5 is a post and rail diagram illustrating a continuation of the call flow from FIG. 4, where the top of FIG. 5 continues from the bottom of FIG. 4.

FIG. 6 is a post and rail diagram illustrating a continuation of the call flow from FIG. 5, where the top of FIG. 6 continues from the bottom of FIG. 5.

FIG. 7 is a post and rail diagram illustrating a continuation of the call flow from FIG. 6, where the top of FIG. 7 continues from the bottom of FIG. 6.

### DETAILED DESCRIPTION OF THE EMBODIMENT(S)

For clarity and simplicity, the present specification shall refer to structural and/or functional elements, relevant standards and/or protocols, and other components that are commonly known in the art without further detailed explanation as to their configuration or operation except to the extent they have been modified or altered in accordance with and/or to accommodate the embodiment(s) presented herein. Moreover, the apparatuses and methods disclosed in the present specification are described in detail by way of examples and with reference to the figures. Unless otherwise specified, like numbers in the figures indicate references to the same, similar or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific materials, techniques, arrangements, etc. are either related to a specific example presented or are merely a general description of such a material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to the figures.

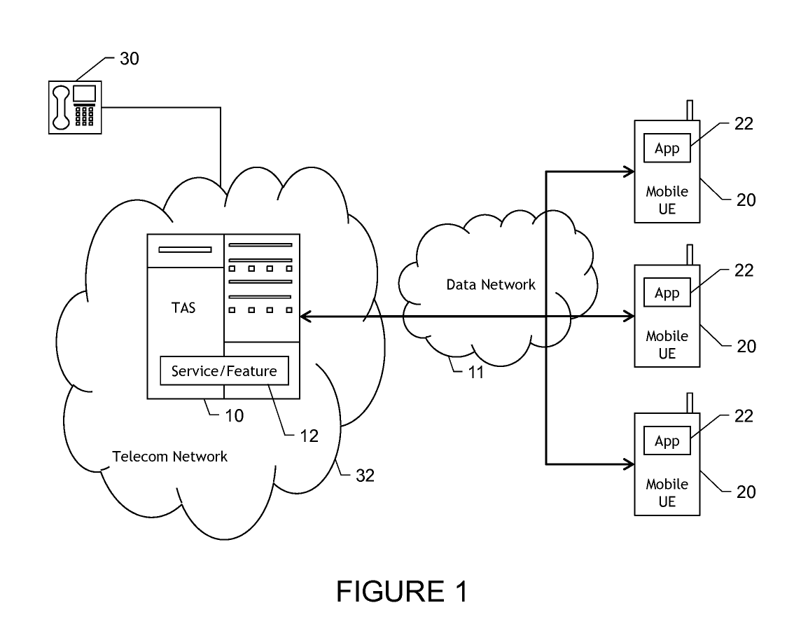

With reference now to FIG. 1, in general, the present specification relates in part to a telephony feature and/or service which allows a calling party to place a call to a single emergency contact or other like telephone number, directory number or other like address to simultaneously (or substantially simultaneously) attempt to reach one or more called parties; or more specifically the user equipment (UE) of one or more called parties. As shown, the service or feature (indicated by reference numeral 12) is implemented via a server side application or process running on a telephony application server 10 that permits users and/or subscribers to selectively employ their respective mobile smart telephones or other like user equipment (UE) 20 for connecting to and/or answering telephone calls placed to a single designated telephone number, directory number or other like address, which for purposes of simplicity herein shall be nominally referred to as the emergency contact number (ECN). In practice, another client side application (indicated by reference numeral 22) for utilizing and/or configuring the aforementioned feature or service 12 may be downloaded and/or otherwise installed on each of the users' mobile UE 20. As shown, the telephony application server (TAS) 10 and mobile UEs 20 (and/or the service 12 and the applications 22) may communicate via a suitable data network 11. While three mobile UEs 20 with associated applications 22 supported thereon are shown in FIG. 1, it is to be appreciated that in practice there may be more or fewer than three.

Suitably, the users may selectively configure their applications 22 so that when a call is placed and/or directed to the ECN, e.g., from a calling party 30 over a telecommunications network 32, all the UEs 20 (with suitably configured applications 22) may be alerted, either simultaneously or substantially simultaneously. Optionally, the network 32 may include a Public Switched Telephone Network (PSTN), a mobile network, a local access network, etc. and/or some combination thereof. In practice, each application 22 may selectively post, send or otherwise provide one or more subscriptions or notification requests to the TAS 10 administering and/or providing the service 12, to be notified thereby of certain call events associated with the ECN, e.g., a subscription or notification request may ask that the posting application 22 or UE 20 be notified whenever a call is placed or directed to the ECN.

Accordingly, when the call from the calling party 30 is placed and/or directed to the ECN, the call is recognized by the TAS 10 (and/or application 12) as one for which there is one or more active subscriptions or outstanding notification requests. Accordingly, the call is parked or the processing or handling of the call is at least temporarily suspended or delayed, while the TAS 10 (and/or application 12), in response to the subscriptions or requests, notifies the subscribing applications 22 and/or UEs 20 of the impending call. In response to this notification, the notified applications 22 may trigger their UE 20 to alert or request that the UE 20 on which they are running provide a designated alert. For example, the alert may include, without limitation, any one or more of the following: ringing or playing another audible output from a speaker of the UE; vibrating or other motion; illuminating a display or light emitting diode (LED) or the like on the UE; showing an icon or message or providing other visual output on a display of the UE; etc. Suitably, the alert in this case may be customized to indicate an emergency call and/or otherwise differentiate it from other alerts.

Suitably, in conjunction with and/or in addition to triggering the UE 20 to alert, the notified applications 22 also provide users on their respective UEs 20 the option to connect or pick-up the call and/or the option to ignore or not pick-up the call. In practice, the application 22 may produce and/or respond to respective soft-buttons provided on a display of the UE 20 or other selection provisions provided for the user to make a desired selection of the foregoing options.

In response to a user selecting the option to connect or pick-up the call, the application 22 triggers the UE 20 to place a call to the ECN. In turn, the TAS 10 (and/or the application 12) again recognizes this call as being one for which there are one or more active subscriptions and/or outstanding notification requests (i.e., insomuch as the call is directed to the ECN). Moreover, the TAS 10 (and/or the application 12) further recognizes the call as being from a UE 20 running an application 22 which posted the subscription and/or otherwise lodged the notification request. Under these conditions, the TAS 10 (and/or the application 12) signals for and/or otherwise connects the call from the UE 20 with the previously parked call from the calling party 30. Additionally, the TAS 10 (and/or the application 12) further notifies the other applications 22 with active subscriptions and/or outstanding notification requests (and/or the UE 20 on which they are running), that the call from the calling party 30 to the ECN has been answered and/or connected. Suitably, this call connected or answered notification also indicates which UE 20 the call was connected to or answered by.

Accordingly, in response to receiving the aforementioned call connected/answered notification, the so notified applications 22 may cease alerting and/or trigger or request their UE 20 to cease alerting. Optionally, the so notified applications 22 may also display or otherwise output or prompt the UE 20 to display or otherwise output the identity of the party and/or UE 20 to which the call was connected. Further, the so notified application 22 and/or UE 20 may provide an option to join the call in progress, e.g., via a soft-button provided on the display of the UE 20 or via other suitable selection means.

In response to a user opting to join the call in progress, the application 22 triggers the UE 20 to place a call to the ECN. In turn, the TAS 10 (and/or the application 12) again recognizes this call as being one for which there are one or more active subscriptions and/or outstanding notification requests (i.e., insomuch as the call is directed to the ECN). Moreover, the TAS 10 (and/or the application 12) further recognizes the call as being from a UE 20 running an application 22 which posted the subscription and/or otherwise lodged the notification request; and further recognizes that a call is already in progress and/or has been previously answered or connected for this ECN. Under these conditions, the TAS 10 (and/or the application 12) provides and/or triggers signaling for and/or otherwise connects the new call from the joining UE 20 to a conference bridge or the like and moves or otherwise transfers thereto the parties from the in progress call between the previously connected UE 20 and the calling party 30.

In one suitable embodiment, when the call is terminated or ended, the TAS 10 (and/or application 12) provides a suitable call event notification to each application 22 and/or UE 20, e.g., which was not previously joined or connected to the call. Accordingly, the option to join the call is simply removed in response to such a notification.

Optionally, each application 22 may be configured such that when the application 22 is launched or otherwise started to run on the UE 20, the application 22 and/or UE 20 posts or provides a subscription or otherwise sends a notification request to the TAS 10 and/or application 12 to be notified thereby if and/or when a call is placed or directed to the ECN. Accordingly, when such a call is identified and/or detected, the TAS 10 and/or application 12 in response to the subscription provides the requested notification to the application 22 on the UE 20. In this way, the UE 20 and/or application 22 is notified of calls placed or being directed to the ECN, e.g., from a calling party 30.

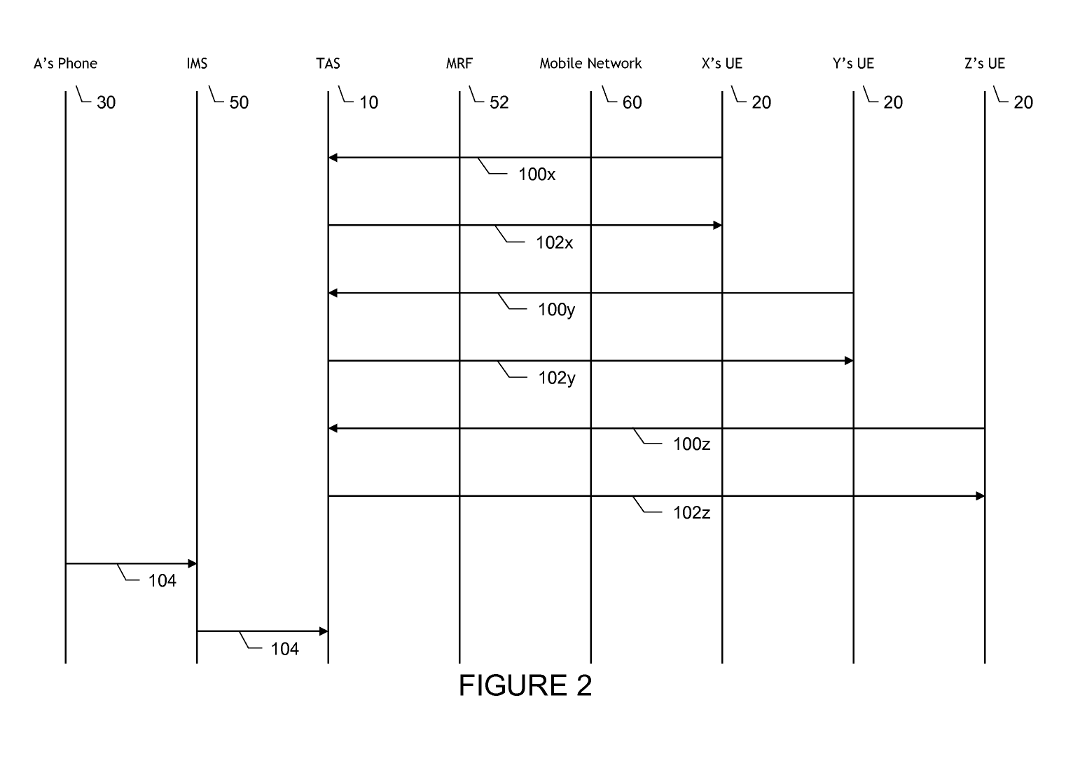

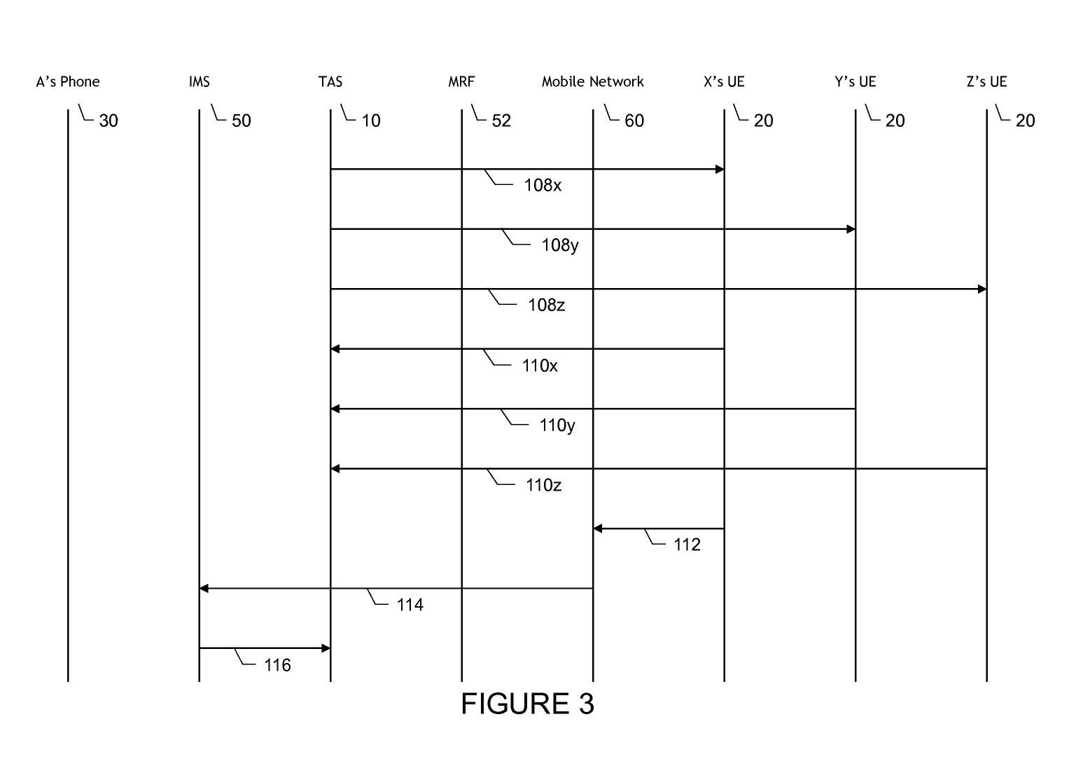

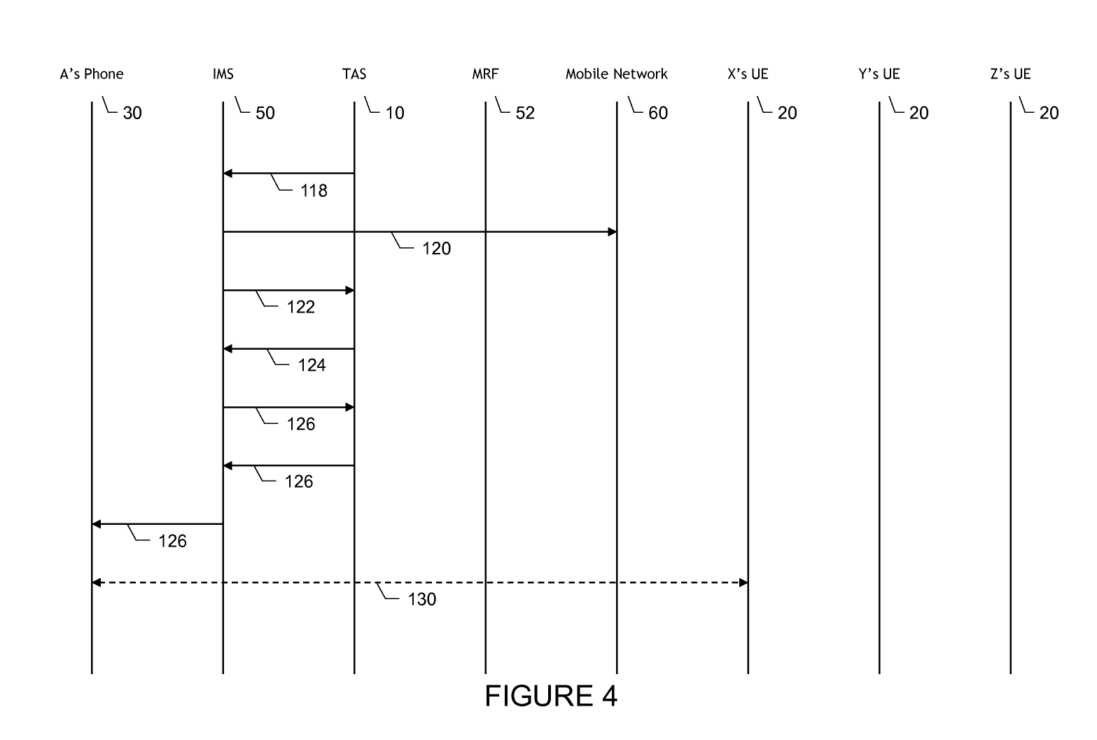

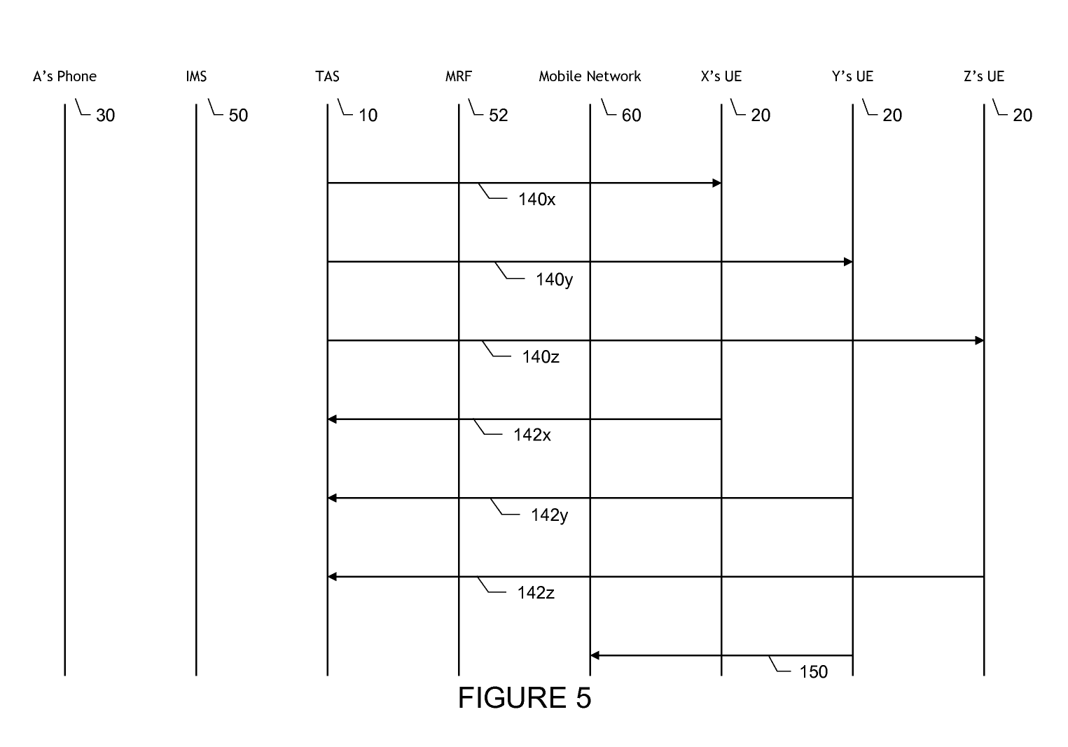

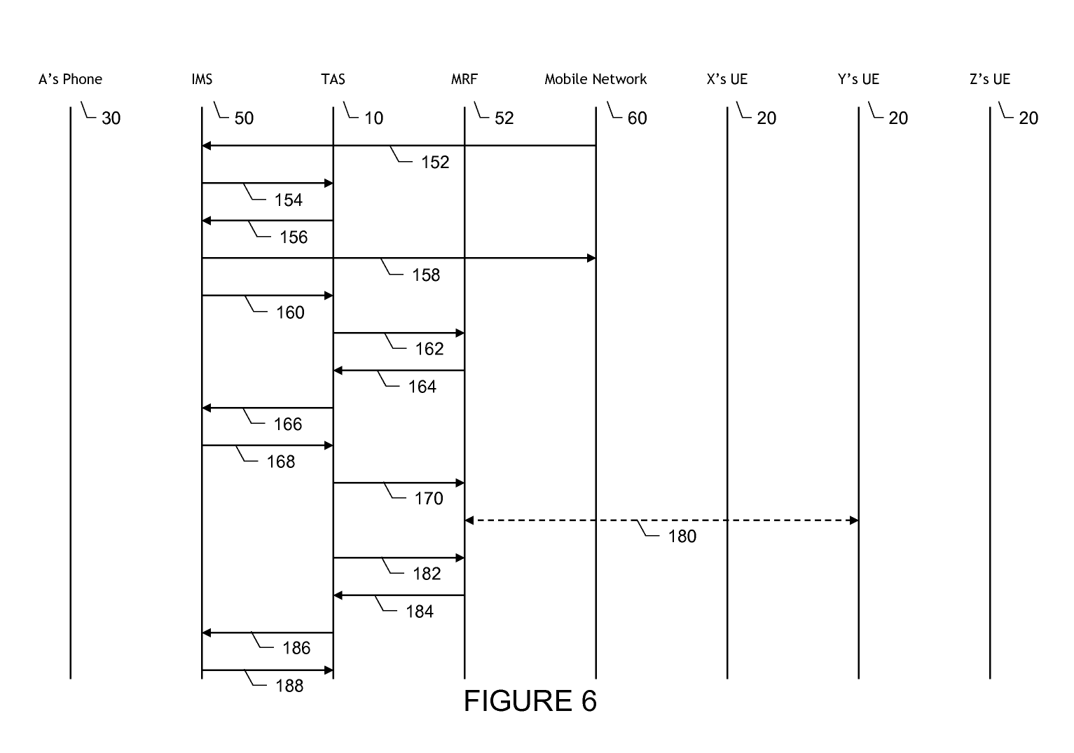

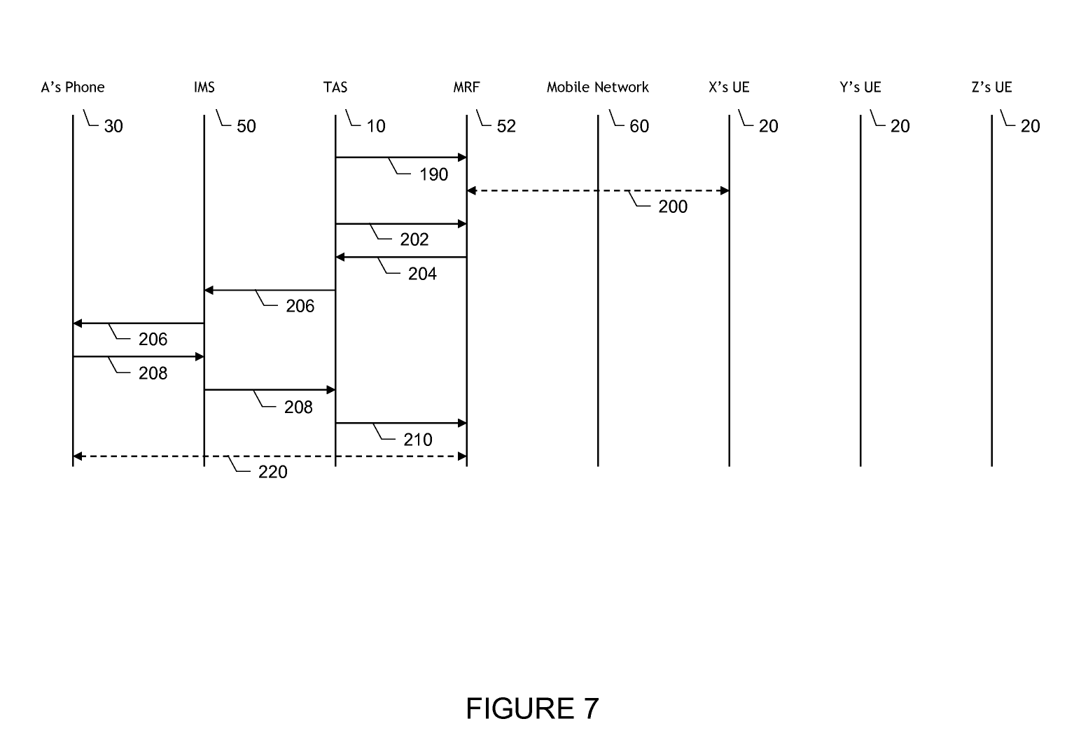

With reference to FIGS. 2 through 7, there is illustrated an exemplary call flow suitable for practicing aspects of the present inventive subject matter. As shown, a number of network entities and/or network nodes or components participate in the illustrated call flow, including: a calling party A that uses their telephone 30 or the like to place a call to the ECN; an Internet Protocol (IP) Multimedia Subsystem (IMS) 50; the TAS 10; a Media Resources Function (MRF) 52; a mobile network 60; and a plurality of UEs 20 for respective users X, Y and Z. In the illustrated call flow, various messages and/or signaling are exchanged between the aforementioned network entities, nodes, etc. Suitably, each network entity, node, etc. is therefore in the usual manner operatively connected to and/or otherwise in communication with the other network entities, nodes, etc. to which messages and/or signals are sent and/or from which messages and/or signals are received. While certain network entities, nodes, etc. are shown in the illustrated call flow, it is to be appreciated that as appropriate and/or in other various alternate embodiments, other intervening and/or otherwise arranged network entities, nodes, etc. (which are not shown) may be utilized in practice in the usual manner to route, forward, translate and/or otherwise facilitate the transmission of the various messages and/or signals.

For the purpose of this exemplary call flow, it is assumed that each user X, Y and Z has signed up for, registered and/or otherwise has active for their mobile UE 20 the feature or service 12 administered by the TAS 10, and have downloaded or otherwise had installed the application 22 on their UE 20. Suitably, the users X, Y and Z have also configured their applications 22 so that calls to the ECN will selectively cause or trigger their UEs 20 to alert under certain conditions. For example, when an application 22 is launched and/or otherwise running on a given UE 20, the application 22 posts a subscription or sends a notification request to the TAS 10 and/or the application 12 administer thereby. Suitably, each subscription or request identifies the application 22 and/or UE 20 posting the subscription or making the request (e.g., with the address or telephone number or DN or other ID of the UE 20) and indicates the ECN to which the subscription or request relates.

As shown in FIGS. 2 through 7, the applications 22 running on the UEs 20 post subscriptions or otherwise send notification requests 100x, 100y and 100z to the TAS 10, requesting notification when the ECN is called. Suitably, each subscription or notification request message 100x/100y/100z may take the form of a Hypertext Transfer Protocol (HTTP) POST that identifies the UE 20 from which it comes, e.g., via its address, DN or other like UE identifier, and requests notification when a call is directed to the ECN. In response, the TAS 10 and/or application 12 optionally returns a confirmation 102x/102y/102z for each of the subscriptions or requests, e.g., via an HTTP 201 CREATED message or the like.

At some time later (but while the subscriptions or notification requests are still in effect and/or active), party A places a call to the ECN, e.g., by dialing the same on party A's telephone 30. Accordingly, a suitable message or signal 104 is directed to the IMS 50. For example, the message or signal 104 may be a Session Initiation Protocol (SIP) INVITE message or the like and/or include a Session Description Protocol (SDP) Offer or the like which indicates the DN or address being called, i.e., the ECN in this case, and the address or DN or other like identifier of the calling party, in this that of the telephone 30. In turn, the message or signal 104 is forwarded to the TAS 10.

Upon receiving the forwarded massage or signal 104, the TAS 10 notes the address or DN being called (i.e., the ECN in this case), and since at least one application 22 running on UE 20 has subscribed and/or requested to be notified about calls to the ECN, the call is parked or the processing or handling of the call is at least temporarily suspended or delayed, while the TAS 10 (and/or application 12), in response to the subscriptions or requests, notifies the subscribing applications 22 and/or UEs 20 of the impending call. For example, the notifications 108x, 108y and 108z may take the form of an HTTP POST that identifies the ECN and indicates a call is being directed thereto, and it may also indicate the identity (i.e., address and/or DN) of the calling party, in this case party A or the address or ND or telephone number or other ID associated with the telephone 30.

In response to receiving the notifications 108x/108y/108z, each application 22 and/or UE 20 on which the application 22 is running, may return a reply 110x, 110y and 110z indicating safe receipt of the corresponding notification. For example, these replies may take the form of an HTTP: 200 OK message or signal or the like. Additionally, in response to the notifications 108x/108y/108z, the respective applications 12 and/or the UEs 20 alert accordingly as described above and each provides the respective user the option to connect with and/or pick-up the call as described above.

In the illustrated example, user X is the first of the users X, Y and Z to select the option to connect with and/or pick-up the call. Accordingly, the application 22 running on user X's UE 20 triggers a call to be placed from the UE 20 to the ECN. Therefore, as shown, a call set-up exchange 112 and/or appropriate signaling and/or massages are passed to the mobile network 60, which in turn sends or routes a suitable signal or message 114 to the IMS 50, e.g., such as an Integrated Services Digital Network (ISDN) User Part (ISUP) Initial Address Message (IAM). Suitably, the signal or message 114 includes the address and/or DN to which the call is being directed, in this case the ECN, and address or DN or other identity of the calling UE 20, in this case X's UE 20. In response, the IMS 50 provides a suitable signal or message 116 to the TAS 10, e.g., in the form a SIP INVITE, which indicates the address and/or DN being called (in this case the ECN) and the identity of the calling party (in this case the address or DN or other ID of X's UE 20).

Suitably, the TAS 10 and/or application 12 recognizes the call is directed to the ECN for which there are active subscriptions and/or outstanding notification requests, and therefore checks the identity of the calling party noted in the message or signal 116 (i.e., the address or DN or other identifier of X's UE 20 in this case), to determine whether or not it matches the ID of an UE which previously posted a subscription and/or otherwise lodged a notification request related to the particular ECN (e.g., from the messages 100x/100y/100z). In this case, it is determined that there is a match. That is to say, the call to the ECN is from an UE 20 that previously posted a subscription related to the ECN. Accordingly, under these conditions, the TAS 10 returns a suitable signal or message 118 to the IMS 50, e.g., a SIP: 200 OK, indicating that it is okay to connect the call from X's UE 20 with the previously parked call from A's telephone 30.

Accordingly, the IMS 50 sends or forwards an answer signal or message 120 or the like to the mobile network 60 and returns to the TAS 10 an acknowledgement 122 to the signal or message 118. The TAS 10 (and/or the application 12) responds to the acknowledgement 122, with a further signal or message 124, e.g., such as a SIP re-INVITE and/or SDP Offer from party A, and the IMS 50 replies to the TAS 10 with a signal or message 126, e.g., such as a SIP:200 OK, which is in turn forwarded to A's telephone 30, e.g., through the IMS 50. In this manner, a call or connection 130 is established between A's telephone 30 and X's UE 20.

Suitably, the applications 22 on the UE 20 of the parties X, Y and Z have subscribed and/or otherwise requested to be notified of call events related to the ECN. Accordingly, the TAS 10 and/or application 12 provides answer notifications 140x, 140y and 140z thereto, indicating that the call or connection 130 has been established. For example, the notification 140x/140y/140z may take the form of an HTTP:POST indicating connection of the call and the identities of the connected parties, e.g., via the relevant DNs, addresses and/or other identifiers. In response to receiving the notifications 140x/140y/140z, each application 22 and/or UE 20 on which the application 22 is running, may return a reply 142x, 142y and 142z indicating safe receipt of the corresponding notification. For example, these replies may take the form of an HTTP: 200 OK message or signal or the like. Additionally, in response to the notifications 142x/142y/142z, the respective applications 12 and/or the UEs 20 may cease alerting accordingly as described above and may provide their respective users the identity of the user or UE picking-up the call as described above. Further, the applications 22 and/or UEs 20 that had not picked-up the call in the first instance may be given the option to still join the call, e.g., as described above.

In the illustrated example, user Y selects the option to join the call. Accordingly, the application 22 running on user Y's UE 20 triggers a call to be placed from their UE 20 to the ECN. Therefore, as shown, a call set-up exchange 150 and/or appropriate signaling and/or massages are passed to the mobile network 60, which in turn sends or routes a suitable signal or message 152 to the IMS 50, e.g., such as an IAM. Suitably, the signal or message 152 includes the address and/or DN to which the call is being directed, in this case the ECN, and address or DN or other identity of the calling UE 20, in this case Y's UE 20. In response, the IMS 50 provides a suitable signal or message 154 to the TAS 10, e.g., in the form a SIP INVITE, which indicates the address and/or DN being called (in this case the ECN) and the identity of the calling party (in this case the address or DN or other ID of Y's UE 20).

Suitably, the TAS 10 and/or application 12 recognizes the call is directed to the ECN for which there are active subscriptions and/or outstanding notification requests, and therefore checks the identity of the calling party noted in the message or signal 154 (i.e., the address or DN or other identifier of Y's UE 20 in this case), to determine whether or not it matches the ID of an UE which previously posted a subscription and/or otherwise lodged a notification request related to the particular ECN (e.g., from the messages 100x/100y/100z). In this case, it is determined that there is a match. That is to say, the call to the ECN is from an UE 20 that previously posted a subscription related to the ECN. Moreover, the application 12 and/or TAS 10 is further aware the call or connection 130 has already been established. Accordingly, under these conditions, it is recognized that this is an attempt by user Y's UE 20 to join the call already in progress. Therefore, the TAS 10 returns a suitable signal or message 156 to the IMS 50, e.g., a SIP 200 OK, indicating that it is okay to join the call from Y's UE 20 with the previously established and/or connected call between X's UE 20 and the calling party A's telephone 30.

Accordingly, the IMS 50 sends or forwards an answer signal or message 158 or the like to the mobile network 60 and returns to the TAS 10 an acknowledgement 160 to the signal or message 156. The TAS 10 (and/or the application 12) responds to the acknowledgement 160, by sending a suitable message or signal 162, e.g., such as a SIP INVITE and/or SDP Offer to the MRF 52. In this way, a conference bridge and/or the like can be reserved or otherwise allocated to which Y's UE 20 is connected. More specifically, as shown, the MRF 52 responds to the message or signal 162 with a reply 164 to the TAS 10. For example, the reply 164 may take the form of a SIP:200 OK message or signal or the like with an SDP Offer from the MRF 52. In turn, the TAS 10 sends or forwards a message or signal 166 to the IMS 50, e.g., such as a SIP Re-INVITE with the SDP Offer from the MRF 52, and the IMS 50 in turn responds with a reply 168, e.g., such as a SIP:200 OK message or signal with an SDP Answer from the call leg to Y's UE 20.

As shown, the TAS 10 then sends an acknowledgement 170 to the message or signal 164 to the MRF 52, e.g., in the form of and/or including a SIP:200 OK message or signal and/or the SDP Answer from the call leg to Y's UE 20. Accordingly, a call leg and/or connection 180 is established between Y's UE 20 and the MRF 52 for the conference.

Additionally, to join X's UE 20 to the conference, the TAS 10 (and/or the application 12) sends a suitable message or signal 182, e.g., such as another SIP INVITE and/or SDP Offer to the MRF 52. More specifically, as shown, the MRF 52 responds to the message or signal 182 with a reply 184 to the TAS 10. For example, the reply 184 may take the form of a SIP:200 OK message or signal or the like with an SDP Offer from the MRF 52. In turn, the TAS 10 sends or forwards a message or signal 186 to the IMS 50, e.g., such as a SIP Re- INVITE with the SDP Offer from the MRF 52, and the IMS 50 in turn responds with a reply 188, e.g., such as a SIP:200 OK message or signal with an SDP Answer from the call leg to X's UE 20.

As shown, the TAS 10 then sends an acknowledgement 190 to the message or signal 184 to the MRF 52, e.g., in the form of and/or including a SIP:200 OK message or signal and/or the SDP Answer from the call leg to X's UE 20. Accordingly, a call leg and/or connection 200 is established between X's UE 20 and the MRF 52 for the conference.

Additionally, to join A's telephone 30 to the conference, the TAS 10 (and/or the application 12) sends a suitable message or signal 202, e.g., such as another SIP INVITE and/or SDP Offer to the MRF 52. More specifically, as shown, the MRF 52 responds to the message or signal 202 with a reply 204 to the TAS 10. For example, the reply 204 may take the form of a SIP:200 OK message or signal or the like with an SDP Offer from the MRF 52. In turn, the TAS 10 sends or forwards a message or signal 206 to the IMS 50, e.g., such as a SIP Re-INVITE with the SDP Offer from the MRF 52; the IMS 50 in turn sends or forwards the message or signal 206 to A's telephone 30, which responds with a reply 208, e.g., such as a SIP:200 OK message or signal with an SDP Answer from A's telephone 30; and in turn the IMS 50 sends or forwards the reply 208 to the TAS 10.

As shown, the TAS 10 then sends an acknowledgement 210 to the message or signal 204 to the MRF 52, e.g., in the form of and/or including a SIP:200 OK message or signal and/or the SDP Answer from A's telephone 30. Accordingly, a call leg and/or connection 220 is established between A's telephone 30 and the MRF 52 for the conference.

Accordingly, the user X and Y and the original calling party A are joined and/or otherwise connected in a common conference call.

As described above, each of the users X, Y and Z in the group are automatically notified that there is an emergency call; however, note that this is achieved by sending a message or signal or other like notification to an application 22 running on their mobile UE 20 rather than by actually placing a call to their mobile UE 20. Each user can configure how he would like to be alerted by this application 22 when such a notification is received; the alert settings used for such an emergency notification may be completely independent of the alert settings used for actual incoming calls. For example, a user may select a ringing pattern for an emergency notification different than the one used for “normal” incoming calls, e.g., so he distinguish an emergency notification from a normal incoming call; in fact; a user could always have the UE 20 ring when there is an emergency notification, even if the UE 20 is currently configured to only vibrate for normal incoming calls.

The above methods, apparatus and/or systems have been described with respect to particular embodiments. It is to be appreciated, however, that certain modifications and/or alteration are also contemplated.

It is to be appreciated that in connection with the particular exemplary embodiment(s) presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that any one or more of the particular tasks, steps, processes, methods, functions, elements and/or components described herein may suitably be implemented via hardware, software, firmware or a combination thereof. In particular, the TAS 10 and/or mobile UE 20 may include a processor, e.g., embodied by a computer or other electronic data processing device, that is configured and/or otherwise provisioned to perform one or more of the tasks, steps, processes, methods and/or functions described herein. For example, a computer or other electronic data processing device employed in the TAS 10 and/or the mobile UE 20 may be provided, supplied and/or programmed with a suitable listing of code (e.g., such as source code, interpretive code, object code, directly executable code, and so forth) or other like instructions or software or firmware (e.g., such as the application 22 or an application to administer the service or feature 12), such that when run and/or executed by the computer or other electronic data processing device one or more of the tasks, steps, processes, methods and/or functions described herein are completed or otherwise performed. Suitably, the listing of code or other like instructions or software or firmware is implemented as and/or recorded, stored, contained or included in and/or on a non-transitory computer and/or machine readable storage medium or media so as to be providable to and/or executable by the computer or other electronic data processing device. For example, suitable storage mediums and/or media can include but are not limited to: floppy disks, flexible disks, hard disks, magnetic tape, or any other magnetic storage medium or media, CD-ROM, DVD, optical disks, or any other optical medium or media, a RAM, a ROM, a PROM, an EPROM, a FLASH-EPROM, or other memory or chip or cartridge, or any other tangible medium or media from which a computer or machine or electronic data processing device can read and use. In essence, as used herein, non-transitory computer-readable and/or machine-readable mediums and/or media comprise all computer-readable and/or machine-readable mediums and/or media except for a transitory, propagating signal.

Optionally, any one or more of the particular tasks, steps, processes, methods, functions, elements and/or components described herein may be implemented on and/or embodiment in one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the respective tasks, steps, processes, methods and/or functions described herein can be used.

Additionally, it is to be appreciated that certain elements described herein as incorporated together may under suitable circumstances be stand- alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred and/or other embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for providing an emergency contact number in a telecommunications network, said method comprising:
identifying a first call directed to an emergency contact number;
notifying a first user equipment of the identified first call;
recognizing a second call from the first user equipment to the emergency contact number as a request to connect the second call with the first call; and,
supporting a connection of the first and second calls with one another.

2. The method of claim 1, said method further comprising:
obtaining a first notification request to notify the first user equipment when a call is directed to the emergency contact number.

3. The method of claim 2, wherein the first notification request is obtained when an application installed on the first user equipment is launched.

4. The method of claim 1, said method further comprising:
at least temporarily parking the first until the second call is recognized.

5. The method of claim 1, wherein the first user equipment is triggered to alert by an application installed on the first user equipment in response to said application receiving notification of the identified first call

6. The method of claim 5, wherein the second call is trigger to be placed by the first user equipment in response to the application installed on the first user equipment receiving a user selection to answer the first call.

7. The method of claim 2, further comprising:
obtaining a second notification request to notify a second user equipment when a call is directed to the emergency contact number; and
notifying the second user equipment of the identified first call.

8. The method of claim 7, further comprising:
recognizing a third call from the second user equipment to the emergency contact number as a request to join the third call with the first and second calls that are already connected with one another.

9. The method of claim 8, wherein the second user equipment is triggered to alert by an application installed on the second user equipment in response to said application receiving notification of the identified first call

10. The method of claim 9, wherein the third call is trigger to be placed by the second user equipment in response to the application installed on the second user equipment receiving a user selection to join the first and second calls that are already connected with one another.

11. The method of claim 1, wherein the first user equipment is a mobile telephone.

12. A telephony application server provisioned to execute the method of claim 1.

13. A method for providing an emergency contact number in a telecommunications network, said method comprising:
sending a first notification request from a first mobile telephone to a node of the telecommunications network, said first notification request requesting that the first mobile telephone be notified if a call is directed to a designated emergency contact number;
receiving at the first mobile telephone a first notification when a first call is directed to the designated emergency contact number;
in response to receiving the first notification, providing a first user of the first mobile telephone an option to connect with the first call; and,
if the first user selects the option, placing a second call from the first mobile telephone to the designated emergency contact number, said second call being connected to the first call.

14. The method of claim 13, further comprising:
sending a second notification from a second mobile telephone to the node of the telecommunications network, said second notification request requesting that the second mobile telephone be notified if a call is directed to the designated emergency contact number;
receiving at the second mobile telephone a second notification when the first call is directed to the designated emergency contact number;
in response to receiving the second notification, providing a second user of the second mobile telephone an option to connect with the first call; and,
if the second user selects the option, placing a third call from the second mobile telephone to the designated emergency contact number, said third call being connected to the first call.

15. The method of claim 14, further comprising:
receiving notification at one of the first and second mobile telephones, when the other of the first and second mobile telephones is connected to the first call.

16. The method of claim 13, wherein the node is a telephony application server.

17. A mobile telephone provisioned to execute the method of claim 13.
